(19) United States
(12) Patent Application Publication
(10) Pub. No.: US 2024/0375156 A1
(43) Pub. Date: Nov. 14, 2024

(54) CONTACT CLEANING APPARATUS

(71) Applicant: Illinois Tool Works Inc., Glenview, IL (US)

(72) Inventors: Matthew BENNING, Glasgow (GB); Matthew FORSTER, Glasgow (GB); Brendan TYNAN, Glasgow (GB)

(21) Appl. No.: 18/661,169

(22) Filed: May 10, 2024

(30) Foreign Application Priority Data
May 11, 2023 (GB) 2306955.2
Apr. 10, 2024 (EP) 24169537.8

(51) Int. Cl. B08B 7/00; B08B 1/20; B08B 1/34; B08B 1/54; E05C 3/00

(52) U.S. Cl. CPC B08B 7/0028; B08B 1/20; B08B 1/34; B08B 1/54; E05C 3/004

(57) ABSTRACT

Disclosed example drawers for a contact cleaning system with a latching mechanism are disclosed. Example drawers comprise at least one drawer slide, a latch mounted on the drawer, and an actuator operable to move the latch between a latching position and a disengaged position. Also provided is an adhesive roll mounting apparatus comprising a housing and a drawer receivable in the housing and being moveable into and out of the housing, the drawer comprising a roll mounting system configured to receive and retain an adhesive roll and a latch mounted on the drawer and moveable between a latching position in which the latch fouls against a stopper element of the housing preventing the drawer being received into the housing and a disengaged position in which the latch is held in a stowed position such that the drawer is received into the housing.

### RELATED APPLICATIONS

The present application claims the benefit of United Kingdom (GB) Patent Application No. 2306955.2, filed May 11, 2023, and of European (EP) Patent Application No. 24169537.8, filed Apr. 10, 2024. The entireties of United Kingdom (GB) Patent Application No. 2306955.2 and European (EP) Patent Application No. 24169537.8 are expressly incorporated herein by reference.

### FIELD OF THE DISCLOSURE

The present disclosure relates to a drawer for a contact cleaning system with a latching mechanism and particularly, but not exclusively, to an adhesive roll drawer for a contact cleaning system with a latching mechanism. Aspects of the disclosure relate to a drawer for a contact cleaning system with a latching mechanism, an adhesive roll mounting apparatus and to a contact cleaning system.

### BACKGROUND

A contact cleaning apparatus typically comprises a housing for each of a contact cleaning roller and an adhesive roll. Each of the roller and the roll is moved into and out of its respective housing via a drawer comprising a drawer slide mounted one at each side of the housing. The drawer slides, typically formed of an outer and inner member, are mounted one on each side of the housing, the outer members being extendible out of the housing and the inner members being extendible out of the outer members in a direction parallel with their longitudinal axes. A roller or roll mounting system is carried on the members and is moveable into and out of the housing as the members are retracted and extended into and out of the housing. The members and the mounting system together form a slidable drawer for moving a contact cleaning roller or an adhesive roll into and out of its housing.

The roller or roll mounting system comprises opposed core plugs mounted on the drawer slides. Typically, there is one fixed core plug mounted on the outer members of a drawer slides and a moveable core plug mounted on the inner members of the drawer slides. Each core plug is arranged and configured to fit within a hollow end of a contact cleaning roller core or an adhesive roll core. In this way, the roller or roll is mounted onto the members of the drawer slides by the roller or roll mounting system and is moveable into and out of the housing. The roller or roll is mounted between the fixed core plug and the moveable core plug.

The housing for the adhesive roll is typically mounted directly above and/or directly below the housing for the contact cleaning roller. The relative positioning of the two housings being determined on whether the apparatus is configured for top and/or bottom cleaning of a substrate. When the slidable drawers of both housings are closed, the adhesive roll contacts the surface of the contact cleaning roller so as to remove debris from the surface of the cleaning roller.

If the drawers of both housings are closed but only the contact cleaning roller is in place, the core plugs of the adhesive roll mounting system foul on the surface of the contact cleaning roller. As the contact cleaning roller rotates, the core plugs of the adhesive roll mounting system wear grooves into the surface of the contact cleaning roller, causing damage and therefore reduced cleaning performance of the contact cleaning apparatus.

It is an object of the disclosure to at least mitigate one or more of the problems of the prior art.

### SUMMARY

Aspects of the disclosure provide a drawer for a contact cleaning system with a latching mechanism, an adhesive roll mounting apparatus and to a contact cleaning system as claimed in the appended claims.

According to aspects of the disclosure, there is provided a drawer for a contact cleaning system with a latching mechanism, the drawer comprising at least one drawer slide, a latch mounted on the drawer, and an actuator operable to move the latch between a latching position and a disengaged position.

When the drawer is mounted in a housing, the latch is configured to foul against the housing when in the latching position. In this way, the drawer is prevented from fully closing into the housing. More specifically, the drawer may be partially, but not fully, received in the housing when the latch is in the latching position.

In some examples, the at least one drawer slide is a pair of opposing drawer slides.

In some examples, the or each drawer is slidable into and out of the housing along the drawer slide or drawer slides. Each drawer slide includes an outer member and an inner member. The outer member and inner member are extendable in a telescopic manner.

In some examples, at least one fixed member is mounted to an internal surface of the housing. The outer member of each drawer slide is extendable along a fixed member. The inner member of each drawer slide is extendable out of the housing in a direction parallel with the longitudinal axes of each of the outer and inner members. In this way, the drawer slide is moved to be fully extended from the housing.

In some examples, the drawer slide may only include two members, an outer member mounted to the housing and an inner member extendable out of the outer member.

In some examples, the latch is pivotable between the latching and disengaged positions.

In some examples, the latch is formed of a body comprising a first leg and a second leg, the first leg and the second leg extending at an angle from one another in the same plane from a mutual pivot point. More specifically, the first leg is configured to be acted upon by the actuator causing the latch to pivot from the latching to the disengaged position. The second leg may be configured to protrude outwardly so as to contact a stopper element of a housing of the contact cleaning system in the latching position and to be pivotable into the disengaged position wherein it is retracted so as to move out of contact with the stopper element.

In some examples, each drawer slide comprises at least two members, an outer member attachable to a housing and an inner member extendable out of the outer member in a direction parallel with their longitudinal axes to fully extend the drawer slides.

In some examples, each drawer slide comprises three members, an fixed member attachable to a housing, an outer member extendable along the fixed member, and an inner member extendable out of the outer member. More specifically, outer member and the inner member are extendable in a telescopic manner in a direction parallel with the longitudinal axis of the fixed member.

In some examples, the latch is mounted to an end of the drawer.

In some examples, the drawer comprises a roller or roll mounting system comprising opposed core plugs mounted one at each end of the drawer.

In some examples, the latch is co-mounted on the drawer at the same end as one of the core plugs.

According to another aspect of the disclosure, there is provided an adhesive roll mounting apparatus comprising a housing and a drawer receivable in the housing and being moveable into and out of the housing, the drawer comprising a roll mounting system configured to receive and retain an adhesive roll and a latch mounted on the drawer and moveable between a latching position in which the latch fouls against a stopper element of the housing preventing the drawer being received into the housing and a disengaged position in which the latch is held in a stowed position such that the drawer is received into the housing.

The latch is configured to foul against the housing when in the latching position. In this way, the drawer is prevented from fully closing into the housing. More specifically, the drawer may be partially, but not fully, received in the housing when the latch is in the latching position.

In some examples, the latch is pivotable between the latching and disengaged positions.

In some examples, the latch is formed of a body comprising two legs, extending at an angle from one another in the same plane from a mutual pivot point. More specifically, the first leg is configured to be acted upon by an actuator causing the latch to pivot from the first to the disengaged position. The second leg may be configured to protrude outwardly so as to contact a stopper element of a housing of the contact cleaning system in the latching position and to be pivotable into the disengaged position wherein it is retracted so as to move out of contact with the stopper element.

In some examples, the drawer comprises a pair of opposing drawer slides. More specifically, each of the opposing drawer slides is mountable to the housing so as to allow the draw to slide into and out of the housing.

In some examples, each drawer slide comprises at least two members, an outer member attachable to a housing and an inner member extendable out of the outer member in a direction parallel with their longitudinal axes to fully extend the drawer slides.

In some examples, each drawer slide comprises three members, an fixed member attachable to a housing, an outer member extendable along the fixed member, and an inner member extendable out of the outer member. More specifically, the outer member and the inner member are extendable in a telescopic manner in a direction parallel with the longitudinal axis of the fixed member.

In some examples, the latch is mounted to an end of the drawer.

In some examples, the roll mounting system comprises opposed core plugs mounted one at each end of the drawer.

In some examples, the latch and one of the core plugs are co-mounted at an end of the drawer.

In some examples, the opposed core plugs are each arranged and configured to fit into the hollow ends of an adhesive roll core.

In some examples, one of the opposing core plugs is fixed in position in the drawer.

In some examples, the other of the opposing core plugs is moveable away from the fixed core plug in the drawer. In this way, the moveable core plug may be moved away from the fixed core plug in order to receive an adhesive roll. In some examples, the moveable core plug is mounted at an end of the drawer opposing the fixed core plug.

In some examples, the roll mounting system comprises an actuator operable to move the latch from the latching position to the disengaged position.

In some examples, the actuator is connected to the moveable core plug.

In some examples, the actuator is the moveable core plug. Thus, in some examples, movement of the latch is actuated by movement of the moveable core plug away from the fixed core plug.

In some examples, the moveable core plug has three positions relative to the fixed core plug: a resting position, a biased position and an operating position. The resting position is the closest to the fixed core plug, the biased position is furthest away from the fixed core plug and the operating position is intermediate the resting and biased positions. In the resting position, there is no adhesive roll between the moveable and the fixed core plugs. In the biased position, the distance between the moveable and the fixed core plugs is greater than the length of the adhesive roll to be received and in the operating position, the moveable and the fixed core plugs are each located in their respective hollow ends of the adhesive roll core and are spaced at a distance which allows rotation of the adhesive roll about its longitudinal axis without any translation of the axis of rotation.

In some examples, the moveable core plug, in its operating position, acts on the latch to hold it in the disengaged position. In this way, with an adhesive roll in position, the drawer is fully receivable into the housing.

In some examples, moving the moveable core plug from the resting to the biased position causes the latch to move from the first to the disengaged position.

In some examples, the moveable core plug is mounted to an end of the drawer such that as the drawer is fully extended and the inner members of the drawer slide out of the outer members and away from the fixed members, the moveable core plug moves with the drawer.

In some examples, the apparatus comprises an adhesive roll retained between the opposing core plugs. In such embodiments, the action of the adhesive roll on the moveable core plug holds the moveable core plug in its operating position and thus the latch is retained in the disengaged position. When the adhesive roll is removed from the apparatus, the moveable core plug moves to its resting position and the latch is caused to move from the disengaged position to the latching position. In this latching position, the latch will foul on the housing if an operator tries to close the drawer into the housing.

According to yet another aspect of the disclosure, there is provided a contact cleaning system comprising an adhesive roll mounting apparatus as described above and a contact cleaning roller mounting apparatus comprising a housing and a drawer receivable in the housing and being moveable into and out of the housing, the drawer comprising a roll mounting system configured to receive and retain a contact cleaning roller wherein the adhesive roll mounting apparatus and the contact cleaning roller mounting apparatus together provide a contact cleaning roller configured and located to contact a substrate to be cleaned and an adhesive roll configured and located to remove debris from the contact cleaning roller.

In some examples, the contact cleaning system comprises a sensor configured to detect whether the drawer is fully receivable in the housing, and to prevent activation of the contact cleaning system when the drawer is not fully receivable in the housing. In some examples, the sensor is configured to detect whether the latch is in the latching position or the disengaged position. In other examples, the sensor is configured to detect the position of the drawer relative to the housing.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Aspects of the disclosure will now be described by way of example only, with reference to the accompanying drawings, in which:

FIG. 1 shows a side view of an adhesive roll mounting apparatus according to an aspect of the disclosure with the moveable core plug in its resting position and the latch in the latching position protruding from the drawer of the apparatus;

FIG. 2 shows a side view of the adhesive roll mounting apparatus according to the disclosure with the moveable core plug in an operating position and an adhesive roll mounted thereon;

FIG. 3 shows an enlarged view of the moveable core plug in circle A of the apparatus of FIG. 1 in its resting position and the latch in its first, protruding position;

FIG. 4 shows an enlarged view of the moveable core plug in circle B of the apparatus of FIG. 2 in its biased position and the latch in its second, stowed position;

FIG. 5 shows an enlarged view of the moveable core plug during assembly of an adhesive roll in the adhesive roll mounting apparatus according to the disclosure (a) in a resting position, (b) in a biased position and (c) in an operating position;

FIG. 6 shows a perspective view of a contacting cleaning apparatus according to an aspect of the disclosure with a drawer including the adhesive roll mounting apparatus of FIG. 1 in an extended position; and

FIG. 7 shows a cross-sectional view of another contacting cleaning apparatus according to an aspect of the disclosure with a moveable core plug in a resting position.

### DETAILED DESCRIPTION

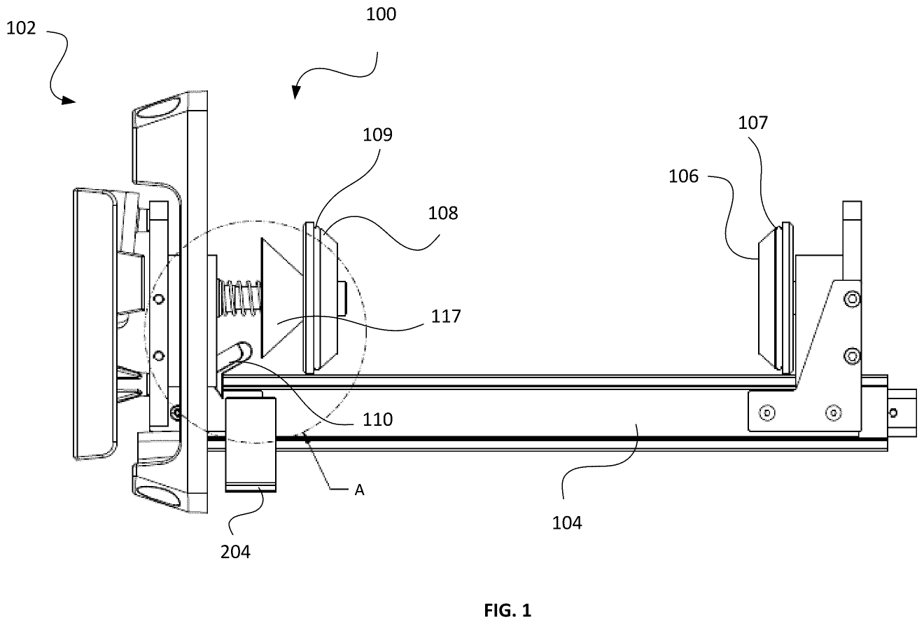

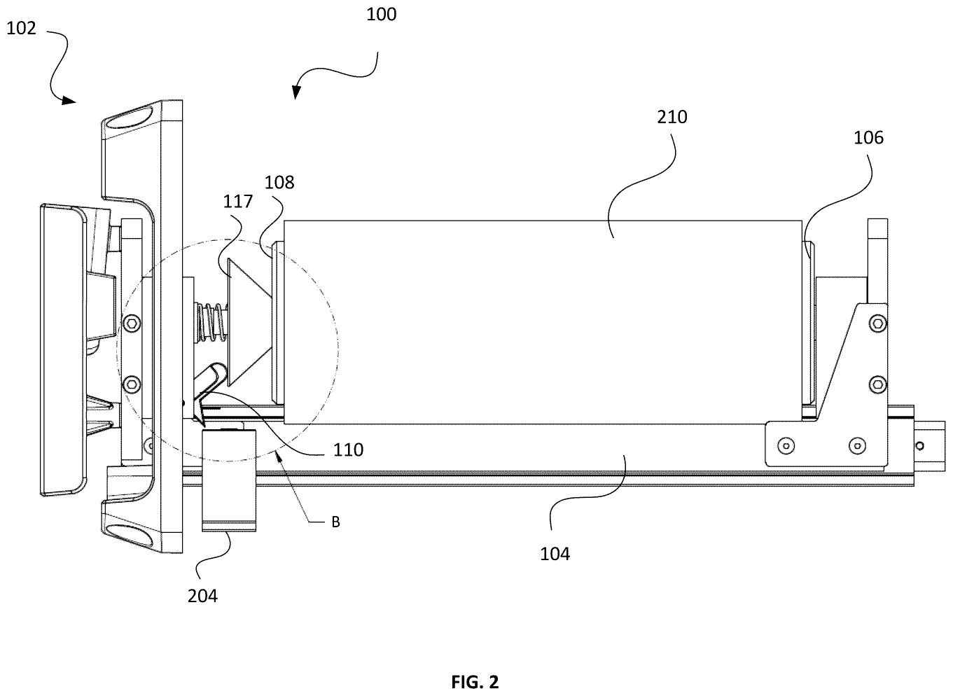

FIGS. 1 and 2 show an adhesive roll mounting apparatus 100 in a drawer 102. The drawer 102 can be mounted in a housing (202, see FIG. 6) of a contact cleaning system (200, see FIG. 6). The drawer 102 includes a pair of opposing drawer slides 104, along which the drawer 102 can be retracted into the housing 202 to a closed position and extended out of the housing 202 to an open position.

As shown in FIG. 1, the roll mounting apparatus 100 includes a fixed core plug 106 and a moveable core plug 108. The fixed core plug 106 is mounted at a first end of the drawer 102 closest to the housing 202 when the drawer 102 mounted to the housing 202 and in an open position. The fixed core plug 106 remains in a fixed position relative to the drawer 102. The moveable core plug 108 is mounted at a second end of the drawer 102, opposite the first end. The moveable core plug 108 is moveable in a linear direction away from the fixed core plug 106 in the drawer 102. The moveable core plug 108 can thus be moved away from the fixed core plug 106 in order to receive an adhesive roll (210, see FIG. 2).

The fixed core plug 106 and moveable core plug 108 each have a frustoconical portion. The frustoconical portion is at an end facing the opposing fixed core plug 106 or moveable core plug 108. The frustoconical portion of each of the fixed and moveable core plugs 106, 108 can be received in a hollow end of an adhesive role core. An adhesive roll (not shown) can thus be mounted between the fixed core plug 106 and moveable core plug 108. FIG. 2 shows an adhesive roll 210 mounted between the fixed core plug 106 and the moveable core plug 108.

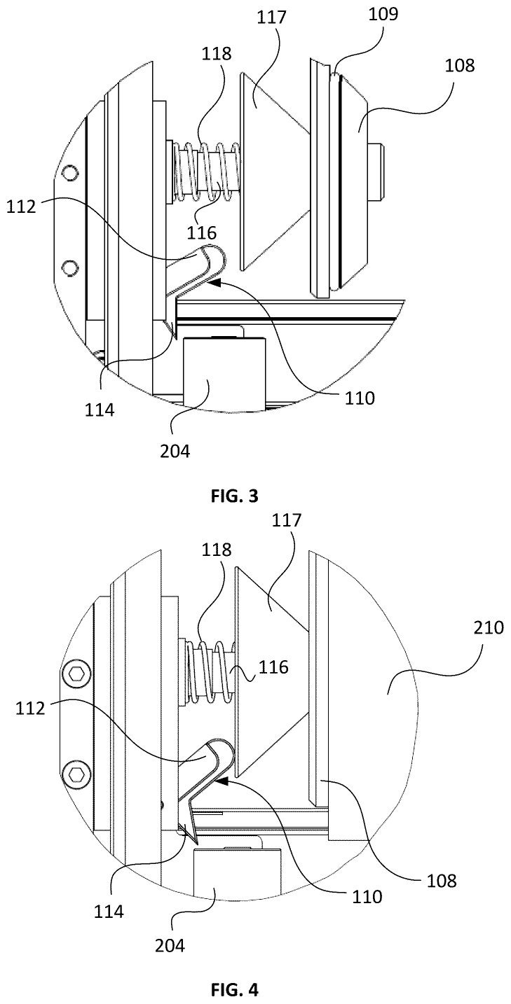

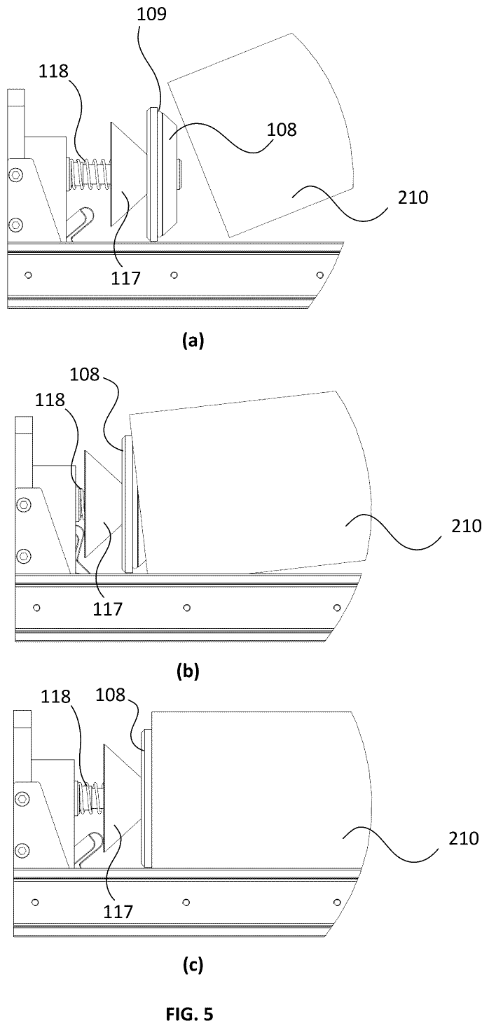

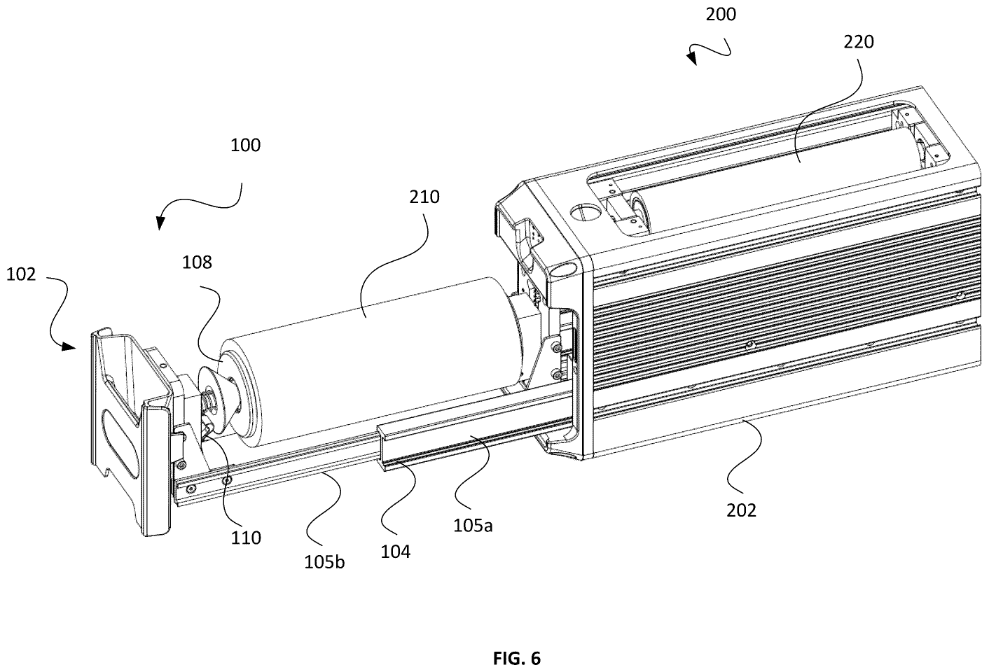

As shown in FIGS. 5(a) to (c), the moveable core plug 108 has three positions relative to the fixed core plug 106, a resting position (see FIG. 5(a)), a biased position (see FIG. 5(b)) and an operating position (see FIG. 5(c)). The moveable core plug 108 is biased towards the resting position, for example by a spring (118, see FIGS. 3 and 4).

In the resting position, as shown in FIGS. 1, 3 and 5(a), the moveable core plug 108 is the closest to the fixed core plug 106. There is no adhesive roll between the moveable core plug 108 and the fixed core plug 106. In the biased position, as shown in FIG. 5(b), the moveable core plug 108 is furthest away from the fixed core plug 106. The distance between the moveable core plug 108 and the fixed core plug 106 is greater than the length of an adhesive roll 210, allowing an adhesive roll 210 to be positioned between the fixed and moveable core plug 106, 108 or removed from between the fixed and moveable core plug 106, 108. In the operating position, as shown in FIGS. 2, 4 and 5(c), the moveable core plug 108 is intermediate the resting and biased positions. The moveable core plug 108 and the fixed core plug 106 are each located in their respective hollow ends of the adhesive roll core and are spaced at a distance which allows rotation of the adhesive roll 210 about its longitudinal axis without any translation of the axis of rotation.

The fixed and moveable core plugs 106, 108 each include a gripping element 107, 108, for improved coupling to the adhesive roll. The gripping element 107, 109 includes a deformable surface. In the example shown, the deformable surface is an O-ring.

As shown in FIGS. 1 and 2, a latch 110 is pivotally mounted at the second end of the drawer 102. The latch 110 is mounted on the drawer 102 by a pin, or by another means which provides a fulcrum about which the latch can pivot. The latch 110, which is shown in an expanded view in FIGS. 3 and 4, is formed of a body comprising a first leg 112 and a second leg 114 extending at an angle from one another in the same plane from a mutual pivot point (not shown). In the example shown, the second leg 114 extends at an angle approximately 90 degrees from the first leg 112.

The moveable core plug 108 includes an actuator 117 fixedly connected to, and moveable with, the frustoconical portion of the moveable core plug 108. A surface of the actuator 117 is moveable into contact with the first leg 112 of the latch 110. The actuator 117 can press against the first leg 112 of the latch 110 to actuate the latch 110 to pivot.

The actuator 117 moves into contact with the first leg 112 when the moveable core plug 108 is in the operating position, pivoting the first leg 112.

FIGS. 1 and 3 show the latch 110 in a first pivotal, latching position and the moveable core plug 108 in the resting position. In this position, the surface of the actuator 117 is not in contact with the first leg 112 and the second leg 114 protrudes outwardly. In the first pivotal position, the second leg 114 of the latch 110 abuts against a side of a stopper element 204 of the housing (202, see FIG. 6), preventing the drawer 102 from sliding from the open position to the closed position. This prevents the drawer 102 from fully closing into the housing 202 when the latch 110 is in the latching position. In other words, the drawer 102 may be partially, but not fully, received into the housing 202 when the latch 110 is in the latching position.

As shown particularly in FIG. 3, the moveable core plug 108 is mounted to its mounting block by a core plug support 116 and a spring 118. The core plug support 116 is an elongate cylindrical member which passes through an aperture in the moveable core plug 108 as the moveable core plug 108 moves towards its mounting block. The sliding of the core plug support 116 through the aperture in the moveable core plug 108 permits translational movement of the moveable core plug towards and away from its mounting block 114. A retaining means is provided to retain the moveable core plug 108 on the core plug support 116. The retaining means may be a fastener, for example a nut.

The moveable core plug 108 is biased away from its mounting block by the spring 118. Thus, the translational movement of the moveable core plug 108 is against the bias of the spring 118. In use, the spring 118 will return the moveable core plug 108 towards the fixed core plug to hold an adhesive roll in place between the moveable core plug 108 and the fixed core plug 106.

In examples, the stopper element 204 may be a block, a lip, or other obstacle fixedly connected or integrally formed with the housing 202. In other examples, the stopper element 204 may be a wall of the housing 202.

FIGS. 2 and 4 show the latch 110 in a second pivotal, disengaged position and the moveable core plug 108 is in the operating position. In this position, the surface of the actuator 117 acts on the first leg 112 and the second latch leg 114 is retracted. In the disengaged position, the latch 110 is pivoted so as to retract the second leg 114 such that the second leg 114 no longer comes into contact with the stopper element 204, permitting the drawer 102 to be slid between the open position and the closed position. Thus, the drawer 102 can be fully received into the housing 202.

The latch 110 described herein is pivotable between the latching and disengaged positions. In other examples, the latch 110 may be slidable, or otherwise moveable, between the latching and disengaged positions so as to prevent and/or permit the drawer 102 to slide between open and closed positions.

FIG. 6 shows a contact cleaning system 200 including a housing 202. The drawer 102, including the adhesive roll mounting apparatus 100, is slidable into and out of the housing 202 along the drawer slides 104. Each drawer slide 104 includes an outer member 105a, an inner member 105b. The outer member 105a, inner member 105b are extendable in a telescopic manner. In one example, a fixed member is mounted to an internal surface of the housing 202. The outer member 105a is extendable along the fixed member, and the inner member 105b is extendable out of the outer member 105a in a direction parallel with the longitudinal axes of each of the outer and inner members 105a, 105b to fully extend the drawer slides 104. According to another example, the drawer slide 104 may only include two members, an outer member mounted to the housing 202 and an inner member extendable out of the outer member.

A contact cleaning roller 220 is mounted in the housing 202. An adhesive roll 210 is mounted in the adhesive roll mounting apparatus 100. The adhesive roll mounting apparatus 100 containing the adhesive roll 210 is slidable into, and fully receivable within, the housing 202 so that the adhesive roll 210 can be positioned in alignment with the contact cleaning roller 220. During use of the contact cleaning system 200, the adhesive roll 210 is positioned such that the surface of the adhesive roll is in contact with the surface of the contact cleaning roller 220.

The contact cleaning system 200 may include a sensor to detect whether the drawer is able to be fully received in the housing 202. For example, the sensor may detect the position of the latch 110 or the sensor may detect the position of the drawer 102. When the sensor detects that the drawer 102 is not able to be fully received in the housing 202, for example the latch 110 is in the latching position or the drawer 102 is protruding from the housing 202, the sensor can prevent the contact cleaning apparatus 200 from being activated. When the sensor detects that the drawer 102 can be fully received in the housing 202, for example the latch 110 is in the disengaged position or the drawer 102 is fully received in the housing 202, the sensor can enable the contact cleaning apparatus 200 to be activated. The sensor may act as a switch to prevent or enable the activation of the contact cleaning apparatus 200. Alternatively, the sensor may send the information to a controller of the contact cleaning apparatus 200 which controls the activation of the contact cleaning apparatus 200.

With reference to FIGS. 1 to 6, assembly of an adhesive roll 210 in the contact cleaning apparatus 200 will now be described. An end of the adhesive roll 210 is placed against the moveable core plug 108. The adhesive roll 210 can be used to move the moveable core plug 108 from the resting position (as shown in FIG. 5(a)) to the biased position (as shown in FIG. 5(b)). This allows the adhesive roll to be positioned between the moveable core plug 108 and the and the fixed core 106 plug such that an opposing end of the adhesive roll 210 can receive the fixed core plug 106 in the adhesive roll core. The moveable core plug 108 is then moved to the operating position (as shown in FIG. 5(c)) to hold the adhesive roll 210 in place. This movement of the moveable core plug 108 pushes the surface of the actuator 117 against the first leg 112, causing the latch 110 to pivot and the second latch leg 114 to be retracted away from the stopper element 204, as shown in FIG. 4. The adhesive roll 210 is then retained between the moveable core plug 108 and the fixed core plug 106 (as shown in FIG. 2), the moveable core plug 108 remains in the operating position and the actuator 117 holds the latch 110 in the disengaged position. The drawer 102 is then slid to a closed position such that it is fully received into the housing 202. With the drawer 102 in the closed position, the adhesive roll 210 contacts the contact cleaning roller 220 and the contact cleaning system 200 can be operated.

During use of the contact cleaning apparatus 200, a substrate is passed over the contact cleaning roller 220 which rotates along the surface of the substrate and removes debris from the substrate. The adhesive roll 210 is rotated by the rotation of the contact cleaning roller 220 and collects the debris from contact cleaning roller 220. During operation of the contact cleaning apparatus 200, an outer surface of the adhesive roll 210 can be replenished, either by adding an adhesive layer to the adhesive roll 210 or removing an adhesive layer from the adhesive roll 210.

When the adhesive roll 210 is no longer usable, an operator will open the drawer 102 and move the moveable core plug 108 to the biased position to remove the spent adhesive roll 210. The moveable core plug 108 is then released and returns to the resting position by spring bias. As the moveable core plug 108 moves to the resting position, the actuator 117 releases the first leg 112 causing the latch 110 to pivot back to the latching position and the second leg 114 to protrude, as shown in FIG. 3. If the operator tries to close the drawer 102, the second leg 114 will foul on the stopper element 204 preventing the drawer 102 from being fully received into the housing 202. A fresh adhesive roll 210 can then be replaced between the moveable core plug 108 and the fixed core plug 106, as outlined above.

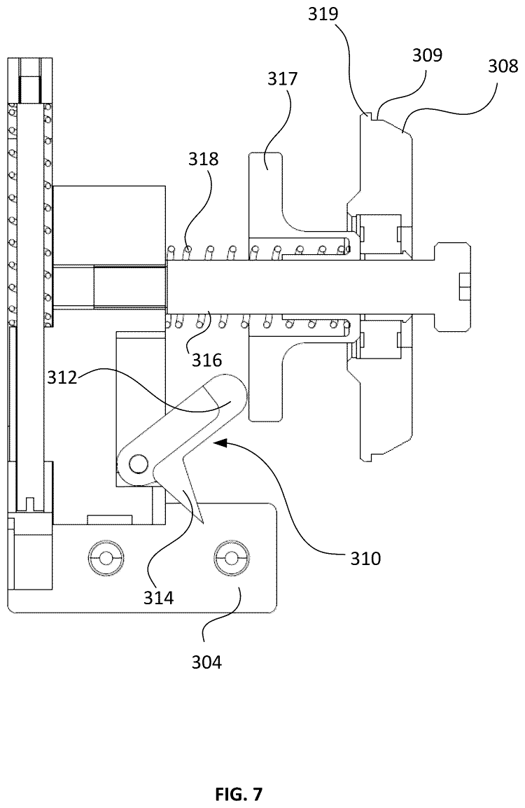

As shown in FIG. 7, there is shown another example of a latch 310 and moveable core plug 308 according to the disclosure in a resting position. Where the features are the same as the example of FIG. 1 to FIG. 6, the reference numbers are also kept the same, but with a “3” as the initial digit.

Similar to the example shown in FIG. 1 to FIG. 6, a latch 310 is pivotally mounted at a second end of the drawer. The latch 310 is formed of a body comprising a first leg 312 and a second leg 314 extending at an angle from one another in the same plane from a mutual pivot point (not shown). In the example shown, the second leg 314 extends at an angle approximately 90 degrees from the first leg 312.

The moveable core plug 308 includes an actuator 317 fixedly connected to, and moveable with, the frustoconical portion of the moveable core plug 308. The actuator 317 is a flanged block. The actuator 317 allows a user to pull back the spring-loaded section by hand, moving the moveable core plug 308 towards the mounting block 314 to aid replacement of the adhesive roll.

A surface of the actuator 317 is moveable into contact with the first leg 312 of the latch 310. The actuator 317 can press against the first leg 312 of the latch 310 to actuate the latch 310 to pivot.

The actuator 317 moves into contact with the first leg 312 when the moveable core plug 308 is in the operating position, pivoting the first leg 312.

The moveable core plug 308 includes a gripping element 309. The gripping element 309 is a cylindrical surface. The circumference of the cylindrical surface is configured to provide an interference fit with the adhesive roll core. Optionally, and the fixed core plug (not shown) also includes a corresponding gripping element.

The moveable core plug includes a stopping element 319. The stopping element 319 is configured to abut the adhesive roll core and limit axial movement of the adhesive roll when it is in the loaded position.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing examples, but also any embodiments which fall within the scope of the claims.

### LIST OF PARTS

Adhesive roll mounting apparatus 100
Drawer 102
Drawer slides 104
Outer member 105a
Inner member 105b
Fixed core plug 106
Gripping element 107
Moveable core plug 108
Gripping element 109
Latch 110
First leg 112
Second leg 114
Core plug support 116
Actuator 117
Spring 118
Contact cleaning system 200
Housing 202
Stopper element 204
Adhesive roll 210
Contact cleaning roller 220
Drawer slide 304
Moveable core plug 308
Gripping element 309
Latch 310
First leg 312
Second leg 314
Core plug support 316
Actuator 317
Spring 318

What is claimed is:

1. A drawer for a contact cleaning system with a latching mechanism, the drawer comprising at least one drawer slide, a latch mounted on the drawer, and an actuator operable to move the latch between a latching position and a disengaged position.

2. The drawer according to claim 1, wherein the latch is pivotable between the latching and disengaged positions.

3. The drawer according to claim 1, wherein the latch is formed of a body comprising a first leg and a second leg, the first leg and the second leg extending at an angle from one another in the same plane from a mutual pivot point.

4. The drawer according to claim 3, wherein the first leg is configured to be acted upon by the actuator causing the latch to pivot from the latching to the disengaged position.

5. The drawer according to claim 3, wherein the second leg is configured to protrude outwardly so as to contact a stopper element of a housing of the contact cleaning system in the latching position and to be pivotable into the disengaged position wherein it is retracted so as to move out of contact with the stopper element.

6. An adhesive roll mounting apparatus, comprising a housing and a drawer receivable in the housing and being moveable into and out of the housing, the drawer comprising at least one drawer slide, a roll mounting system configured to receive and retain an adhesive roll, and a latch mounted on the drawer and moveable between a latching position in which the latch fouls against a stopper element of the housing preventing the drawer being received into the housing and a disengaged position in which the latch is held in a stowed position such that the drawer is received into the housing.

7. The adhesive roll mounting apparatus according to claim 6, wherein the latch is pivotable between the latching and disengaged positions.

8. The adhesive roll mounting apparatus according to claim 6, wherein the at least one drawer slide comprises a pair of opposing drawer slides.

9. The adhesive roll mounting apparatus according to claim 8, wherein the roll mounting system comprises opposed core plugs mounted one at each end of the drawer.

10. The adhesive roll mounting apparatus according to claim 8, wherein one of the opposing core plugs is fixed in position in the drawer and the other of the opposing core plugs is moveable away from the fixed core plug in the drawer.

11. The adhesive roll mounting apparatus according to claim 6, wherein the roll mounting system comprises an actuator operable to move the latch from the latching position to the disengaged position.

12. The adhesive roll mounting apparatus according to claim 11, wherein one of the opposing core plugs is fixed in position in the drawer and the other of the opposing core plugs is moveable away from the fixed core plug in the drawer, and the actuator is connected to the moveable core plug.

13. A contact cleaning system comprising the adhesive roll mounting apparatus according to claim 6 and a contact cleaning roller mounting apparatus mounted in the housing, wherein the contact cleaning roller mounting apparatus comprises a second drawer receivable in the housing and being moveable into and out of the housing, the second drawer comprising a roll mounting system configured to receive and retain a contact cleaning roller wherein the adhesive roll mounting apparatus and the contact cleaning roller mounting apparatus together provide a contact cleaning roller configured and located to contact a substrate to be cleaned and an adhesive roll configured and located to remove debris from the contact cleaning roller.
